(19) United States
(12) Patent Application Publication
(10) Pub. No.: US 2015/0313078 A1
(43) Pub. Date: Nov. 5, 2015

(54) MOWER CONDITIONER KNIFE REMOVAL TOOL WITH WEAR GUAGE

(71) Applicant: CNH Industrial America LLC, New Holland, PA (US)

(72) Inventor: Jeffrey B. Fay, II, Lititz, PA (US)

(73) Assignee: CNH Industrial America LLC, New Holland, PA (US)

(21) Appl. No.: 14/265,431

(22) Filed: Apr. 30, 2014

(51) Int. Cl. A01D 34/64; B66F 15/00

(52) U.S. Cl. CPC A01D 34/64; B66F 15/00

(57) ABSTRACT

A removal and installation tool for a quick release blade of a mower conditioner. The tool has a handle and forked extensions for straddling the blade to release it from its mounting. The tool has a notch in its handle with the edge of the notch furthest from a reference edge on the handle being indicative of the wear limit for a blade in the mower conditioner.

### BACKGROUND

1. Field of the Invention

The subject disclosure relates to mower conditioners, and, more specifically, to tools used to replace mower conditioner blades and to measure wear of their mounting.

2. Description of the Related Art

For a number of years in the agricultural field and most roadside mowing, the disc mower has experienced widespread use. It consists of opposed blades mounted on a rotating cover to cut material. Frequently, disc mowers are utilized in multiples, and for this purpose the rotation of the discs is synchronized. The blades are pivotally mounted to their cover so they will more easily recover when they hit an obstruction.

A key feature of the successful utilization of this technology is an arrangement for quickly changing the individual blades when they are either damaged or no longer sharp enough to perform their function. A number of proposals have been employed to facilitate this feature. They consist of mounting the blades to the rotating housing through a pivotal element and holding the blades on the element through a spring. The blades are then replaced by using a tool to pry the spring clear of the pivotal mounting so that the old blade may be removed and the new blade installed. In time, the pivotal mounting for the blade may wear to the point where it interferes with the means to secure the pivotal mounting to the cover. Currently, operators are required to visually inspect the pivotal mounting to ascertain wear. This involves an inspection of the underside of the cover which is, at best, inconvenient in the field.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

The subject disclosure, in one form, provides a tool for removing and installing mower conditioner blades and for measuring the wear of their mounting elements.

In one form, the subject disclosure includes a removal and installation tool for blades pivotally mounted around the periphery of a cover for a mower conditioner, the blades having openings for pivotal interconnection with corresponding cylindrical surfaces around annular elements mounted on the cover and springs for retaining the blades on the annular elements with pivotal interconnections. The tool includes an elongated handle and a pair of forked extensions for straddling the blades and prying the springs clear of the annular element. The tool has indicia at a predetermined distance from a reference edge on the tool, the predetermined distance being substantially equal to the wear limit of the cylindrical surfaces of the annular elements.

An advantage of the subject disclosure is the measurement of wear from the top side of a mower conditioner.

Another advantage is the measurement of wear with the same tool used to replace the blades on a mower conditioner.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

The above-mentioned and other features and advantages, and the manner of attaining them, will become more apparent and the subject disclosure will be better understood by reference to the following description of an embodiment of the subject disclosure taken in conjunction with the accompanying drawings, wherein:

FIG. 1 is a top view of a portion of a mower conditioner including a tool for measuring wear;

FIG. 2 is a partial side view of the mower conditioner of FIG. 1 taken on lines 2-2 of FIG. 1;

FIG. 3 is a bottom view of FIG. 2 taken on lines 3-3 of FIG. 2;

FIG. 4 is a perspective view of the tool used with the mower conditioner of FIGS. 1-3; and

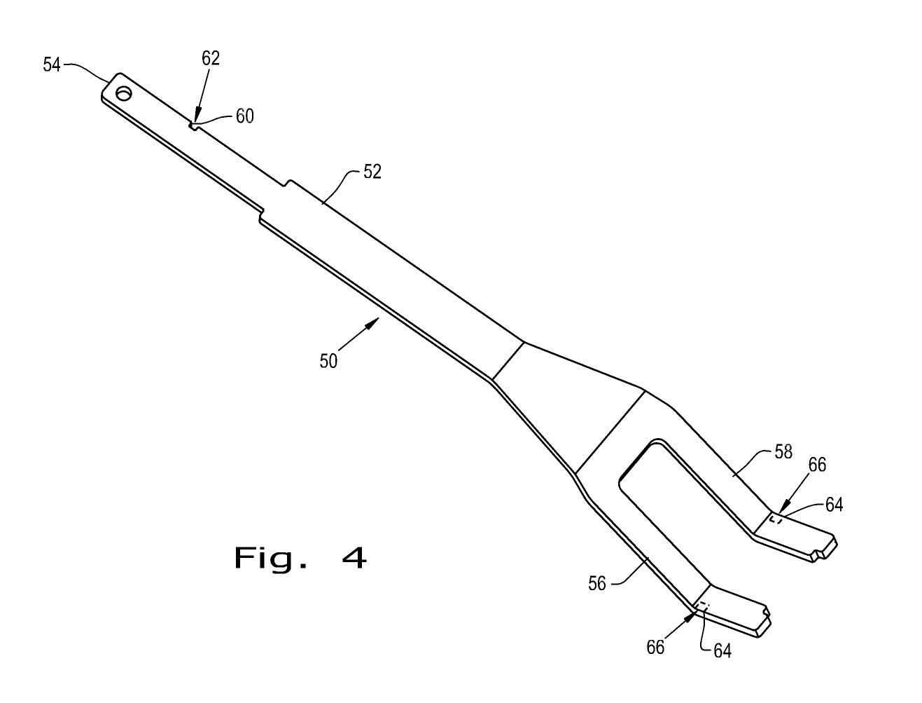

FIG. 5 shows the tool of FIG. 4 used to determine the limits of wear for the mower conditioner set out in FIGS. 1-3.

Corresponding reference characters indicate corresponding parts throughout the several views. The exemplifications set out herein illustrate embodiments of the subject disclosure and such exemplifications are not to be construed as limiting the scope of the subject disclosure in any manner.

### DETAILED DESCRIPTION

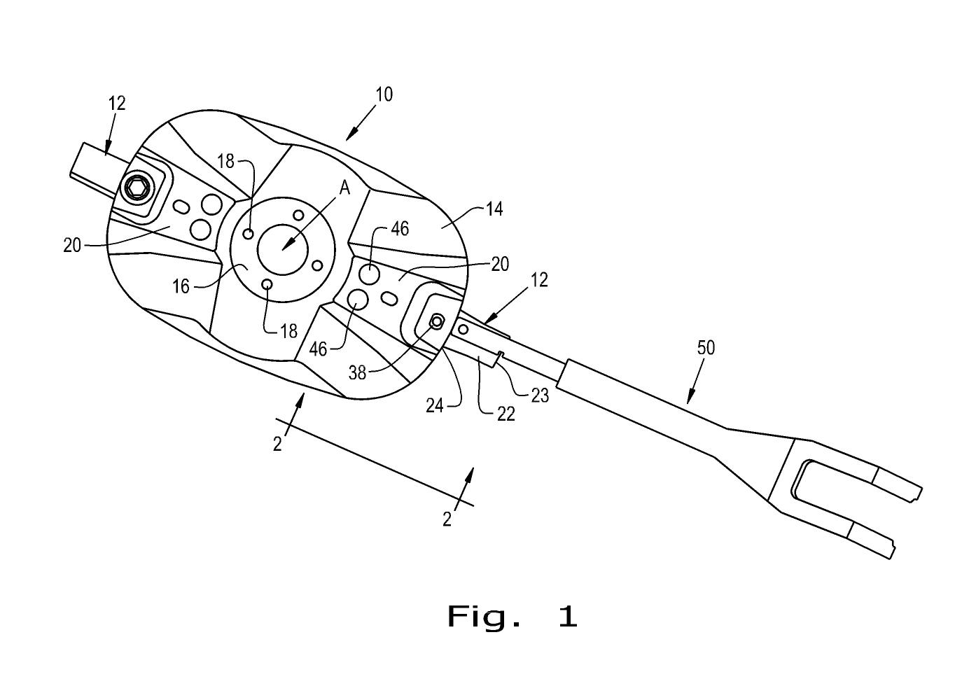

Referring now to the drawings, and more particularly to FIG. 1, there is shown a portion of a mower conditioner 10 including opposed blades 12 mounted on a cover 14 for pivotal rotation about axis A. An annular mounting section 16 on cover 14 includes openings 18 through which appropriate fasteners (not shown) secure housing 14 for rotation about axis A. Recesses 20 in cover 14 provide clearance for mounting of the blades 12, as will be described below.

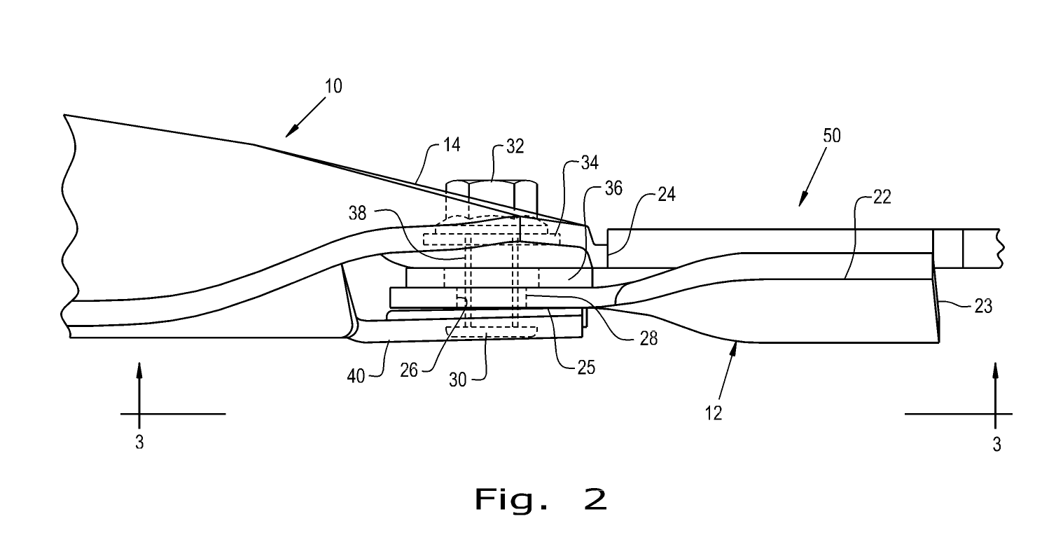

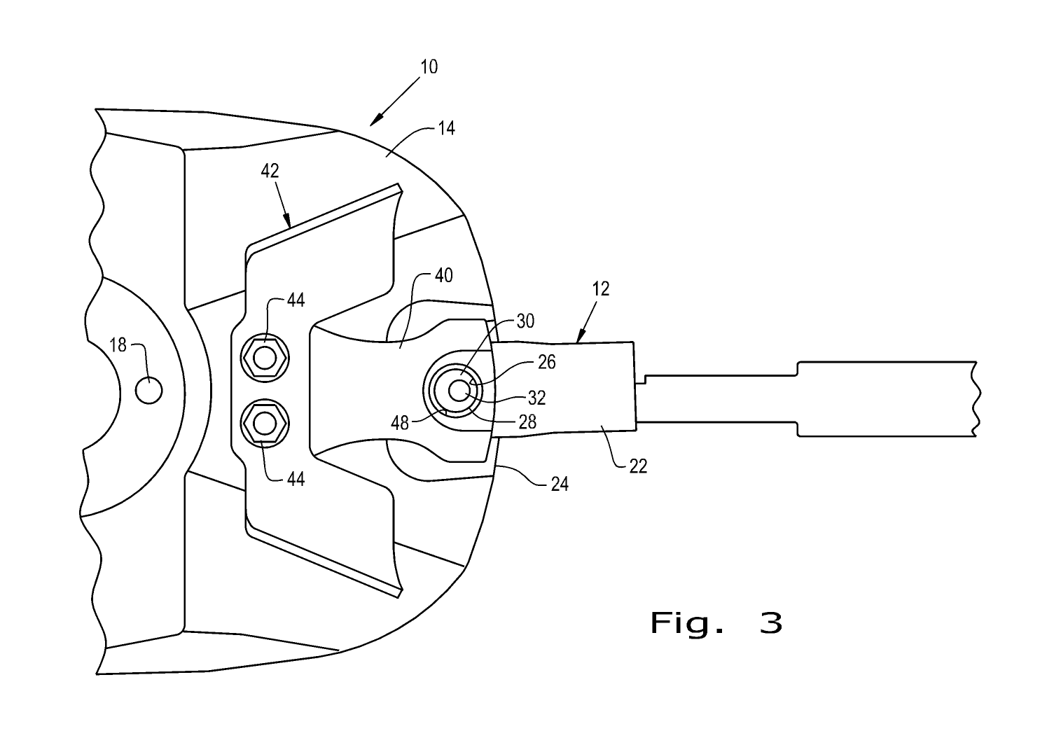

Blades 12 have cutting edges 22, tips 23 and blade roots 25. Blades 12 extend radially outward from the periphery 24 of cover 14. As shown particularly in FIGS. 2 and 3, the blade root 25 has a circular opening 26 which corresponds to a cylindrical surface 28 about which the blades 12 can pivot. Cylindrical surface 28 is formed on a threaded annular element 30, or nut, which is fastened to cover 14 by means of a screw 32 passing through washer 34 on the upper surface of cover 14. A spacer washer 36 is positioned around threaded element 30 and an opening 38 in the root 25 of blade 12 circumscribes the cylindrical surface 28 so that the blade is free to pivot through a limited range.

The blade 12 is held on the threaded element 30 by a spring retainer 40 illustrated particularly in FIGS. 2 and 3. The spring retainer 40 is sandwiched between a deflector 42 and the underside of cover 14 by nuts 44 shown in FIG. 3 and lag screws 46 shown in FIG. 1. An opening 48 in spring retainer 40 allows it to clear the cylindrical surface 28 of threaded element 30 and urge the bottom side of the root 25 of blade 12 against the spacer washer 36 to hold it in place.

In accordance with the subject disclosure, a tool 50 can be provided for removing and installing blades 12 in addition to determining permissible wear between the blades 12 and their pivotal interconnection with the cover 14. The tool 50 can have a handle 52 with an edge 54. Forked extensions 56 and 58 extend from handle 52 and are spaced to straddle blade 12 so that they may be positioned between the underside of cover 14 and the spring retainer 40 to deflect it downward sufficiently to clear threaded element 30 and permit the installation or removal of blades 12. Indicia 60 can be provided on handle 52 to provide an indication that the wear on the pivotal interconnection, namely through threaded element 30 is sufficient to cause threaded element 30 to be replaced. This can be done by placing the edge 54 of tool 50, which may form a reference edge, against the periphery 24 of cover 14 in line with blade 22. A normal range of wear is illustrated in FIG. 3 in which the tip 23 of blade 12 does not reach indicia 60. Indicia 60 can be an edge of a notch 62 furthest from the reference edge 54 that circumscribes a tolerable wear condition for the threaded element 30. The tolerable wear condition is one where the cylindrical surface 28 has not worn to the point where it surface extends into the threads of screw 32.

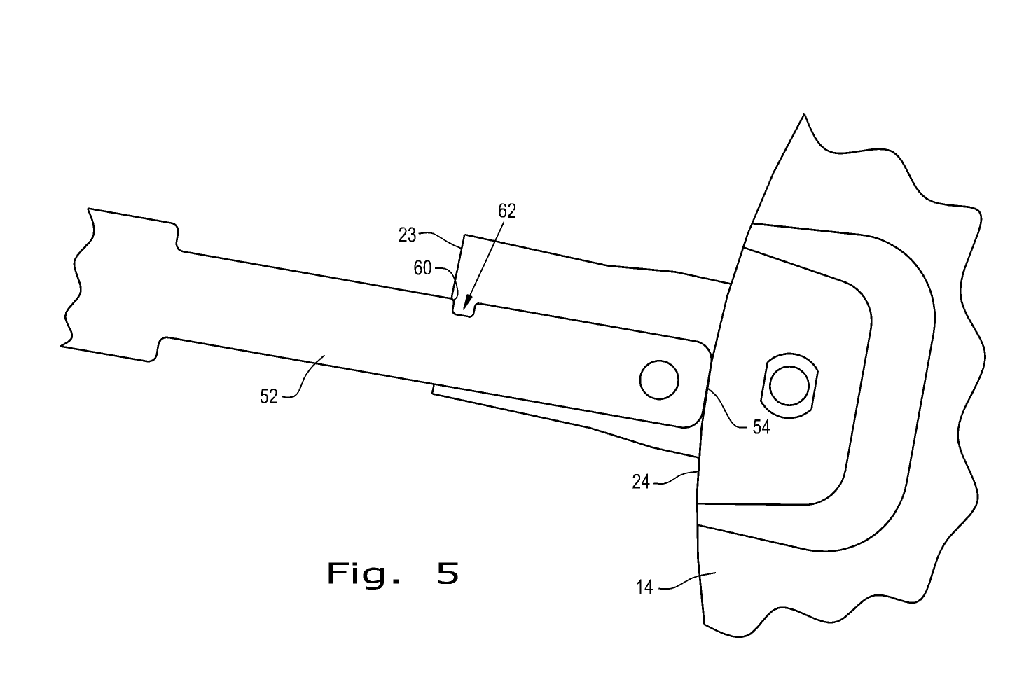

The provision of the indicia 60 on the handle of tool 50 permits removal and installation and wear determination with a single tool, thus eliminating the possibility that a separate measuring device can be lost. As illustrated in FIGS. 1 and 5, the measurement of wear is from the upper side of cover 14 to greatly facilitate operator inspection in the field. Although illustrated on the handle 52, the indicia 60 may be alternately provided either of the forked extensions 56 and 58 as shown by dashed lines 64 including notches 66.

While this invention has been described with respect to at least one embodiment, the subject disclosure can be further modified within the spirit and scope of this disclosure. This application is therefore intended to cover any variations, uses, or adaptations of the invention using its general principles. Further, this application is intended to cover such departures from the subject disclosure as come within known or customary practice in the art to which this invention pertains and which fall within the limits of the appended claims.

What is claimed is:

1. A removal and installation tool for blades pivotally mounted around a cover for a mower conditioner, the cover having a periphery, said blades having openings for pivotal interconnection with corresponding cylindrical surfaces around annular elements mounted on the cover and springs for retaining the blades on the annular elements with pivotal interconnections, said tool comprising:
an elongated handle; and,
a pair of forked extensions connected to said handle, said forked extensions being spaced to straddle the blades and pry the springs clear of said annular elements, said tool having indicia at a predetermined distance from a reference edge on said tool, said predetermined distance being substantially equal to the distance of the blade tips from the periphery of the cover which exceeds the wear limit of the cylindrical surfaces of said threaded elements.

2. The installation and removal tool of claim 1, wherein said handle and forked extensions are in a unitary tool.

3. The removal and installation tool of claim 2, wherein said tool is formed of a metal sheet material.

4. The removal and installation tool of claim 1, wherein said indicia is provided by a notch on the tool with the edge of the notch furthest from the reference edge being the limit of wear.

5. The removal and installation tool of claim 1, wherein the indicia is provided on the handle.

6. The removal and installation tool of claim 5, wherein the handle has a notch with the edge of the notch furthest from the reference edge being the limits of wear.

7. The removal and installation tool of claim 1, wherein the tool is bent for facilitating prying of the spring.

8. The removal and installation tool of claim 1, wherein the indicia is provided on one of said forked extensions.

9. The removal and installation tool of claim 8, having a notch on one of said forks, the end of the fork being said reference surface edge and the edge of the notch being furthest from the reference edge being the limit of wear.
